(19) United States
(12) Patent Application Publication
(10) Pub. No.: US 2015/0154359 A1
(43) Pub. Date: Jun. 4, 2015

(54) METHOD AND SYSTEM FOR GENERATING MEDICAL NARRATIVE

(71) Applicant: CATALIS, INC., Austin, TX (US)

(72) Inventors: Mary Dee Harris, Austin, TX (US); Steven Ray Shipman, Austin, TX (US)

(21) Appl. No.: 14/447,086

(22) Filed: Jul. 30, 2014

Related U.S. Application Data
(63) Continuation of application No. 11/141,244, filed on May 31, 2005, now abandoned.
(60) Provisional application No. 60/576,363, filed on Jun. 2, 2004.

(51) Int. Cl. G06F 19/00

(52) U.S. Cl. CPC G06F 19/322

(57) ABSTRACT

In one particular embodiment, the disclosure is directed to a system including a processor and storage. The storage is accessible by the processor and includes medical findings data and computer-implemented program instructions. The medical findings data include a discrete input. The computer-implemented program instructions are configured to access the medical findings data and are configured to generate at least a portion of a medical narrative based on the discrete input.

### CROSS-REFERENCE TO RELATED APPLICATION(S)

The present application is a continuation of U.S. patent application Ser. No. 11/141,244, filed May 31, 2005, entitled “METHOD AND SYSTEM FOR GENERATING MEDICAL NARRATIVE,” naming inventors Mary Dee Harris and Steve Shipman, which claims priority from U.S. Provisional Patent Application No. 60/576,363, filed Jun. 2, 2004, entitled “METHOD AND SYSTEM FOR GENERATING MEDICAL NARRATIVE,” naming inventors Mary Dee Harris and Steve Shipman, which applications are incorporated by reference herein in their entirety.

### FIELD OF THE DISCLOSURE

This disclosure relates, in general, to methods and systems for generating medical narratives.

### BACKGROUND

In recent years, the cost of medicine including pharmaceuticals and medical procedures has increased. Payers, such as patients, insurance companies, and government assistance providers, attempt to control costs by implementing cost controls and price limits for medical procedures.

On the other hand, physicians and other medical healthcare providers are experiencing increased costs in expenses, such as insurance and practice management. As a result, healthcare providers are experiencing pressure and possibly lost profits from increased expenses and limits on what can be charged.

In addition to price controls and limits, organized payers, such as medical insurance providers and government entities, request considerable paperwork to justify payment. The paperwork generally includes a medical narrative describing the encounter with the patient. Typically, a healthcare provider may dictate the narrative or write the narrative by hand. The narrative is transcribed by a transcriber and provided with the paperwork. This process adds expense to the healthcare provider's practice and may introduce error into the paperwork. The added expense reduces healthcare provider profits and errors may delay payment or lead to payer rejections. As such, an improved process for generating a narrative would be desirable.

### SUMMARY

In one particular embodiment, the disclosure is directed to a system including a processor and storage. The storage is accessible by the processor and includes medical findings data and computer-implemented program instructions. The medical findings data includes a discrete input. The computer-implemented program instructions are configured to access the medical findings data and are configured to generate at least a portion of a medical narrative based on the discrete input.

In another exemplary embodiment, the disclosure is directed to a system including a processor and storage accessible to the processor. The storage includes data that includes a discrete input, a plan file, and computer-implemented instructions. The computer-implemented instructions are configured to access the data and are configured to form a linguistic component object.

In a further exemplary embodiment, the disclosure is directed to a computer-implemented method for generating a medical narrative. The method includes accessing a discrete input associated with a medical finding and generating a medical narrative based on the discrete input.

In another exemplary embodiment, the disclosure is directed to a computer-implemented method for generating a narrative. The method includes providing a set of discrete inputs, generating an entity entry associated with the set of discrete inputs, and generating a set of event entries based on the set of discrete inputs.

### BRIEF DESCRIPTION OF THE DRAWINGS

FIG. 1 is a diagram of an illustration of an exemplary system.

FIG. 2 is a flow diagram of an illustrative method for generating a text narrative.

FIG. 3 is a pictorial of an illustrative example of a discrete input data entry interface.

FIG. 4 is a diagram of an exemplary embodiment of a data system.

FIG. 5 is a flow diagram of an exemplary method for generating a narrative.

FIG. 6 is a flow diagram of an exemplary process for generating a narrative.

FIG. 7 is a diagram of an exemplary organization for plans.

### DESCRIPTION OF THE DRAWINGS

In one particular embodiment, the disclosure is directed to a computer system and methods for generating a text narrative from discrete inputs. In one exemplary embodiment, the text narrative is a medical text narrative derived from a medical workflow associated with a patient encounter. The discrete inputs include medical findings.

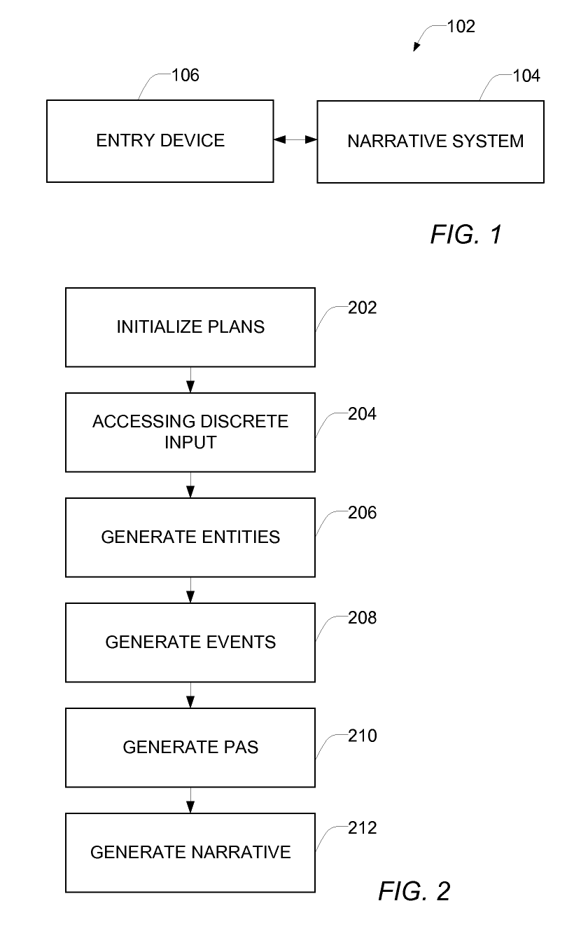

FIG. 1 depicts an exemplary computer system for utilizing text narrative generation. The system 102 includes a narrative system 104 and one or more entry devices 106. Discrete inputs may be entered at the entry device 106 and transferred to the narrative system 104. The narrative system 104 generates a text narrative from the discrete inputs. In one exemplary embodiment, the narrative system 104 transfers the text narrative to the entry device 106.

The narrative system 104 may include a computer server system connected to a network. The entry device 106 may be directly connected to the narrative system 104 or connected to the narrative system 104 via the network. As such, the entry device 106 may be a remote device or a local device. In one exemplary embodiment, the entry device 106 is a portable computational device, such as a handheld device or wireless computer pad-type device.

In one embodiment, the system 102 is a medical system. A healthcare provider (HCP) enters discrete inputs associated with medical findings into an entry device 106 during an encounter with a patient. The medical findings inputs are transferred to the narrative system 104 and a medical narrative is generated based on the medical findings.

FIG. 2 illustrates an exemplary method for generating a text narrative. The method initializes a set of plans, as shown at step 202. Plans describe how to map the discrete inputs into linguistic components and include instructions for creating linguistic component objects associated with the discrete inputs. Plans are described in more detail below.

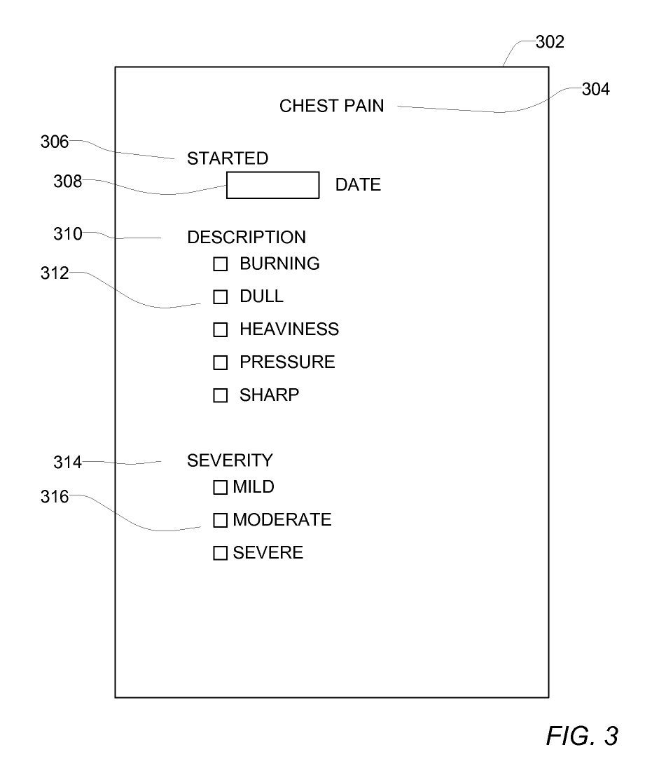

The system accesses the discrete inputs, as shown at step 204. Discrete inputs include bi-state inputs, tri-state inputs, and canned text phrases with or without units of measure. FIG. 3 depicts an exemplary interface 302 for receiving discrete inputs. This exemplary interface 302 includes a chief complaint 304 indicating chest pain. Other categories modify or describe the chest pain. For example, the interface may include a “started” category 306 with a date entry element 308. The date entry element 308 may have units such as hours or a specific day of the year. Another exemplary category includes a “description” category 310. The “description” category 310 includes a set of checkboxes 312 labeled burning, dull, heaviness, pressure, and sharp. In one example, the checkboxes are tri-state elements permitting selection, negation, or non-selection of one or more of the element's set. Another exemplary category is “severity,” which includes a set of checkboxes 316 labeled mild, moderate, and severe. The checkboxes may, for example, be bi-state checkboxes allowing selection or non-selection of one of the set. Alternatively, radio buttons, text boxes, tri-state elements, and bi-state elements may be used to accept discrete inputs. When text boxes are used, the text may generally be a phrase, date, or number that is treated as a whole. For example, text may be treated as a quote or phrase and not dissected or parsed. In another example, checkboxes may be provided for canned text. Canned text includes phrases commonly used or associated with a medical workflow. The canned text may also be treated as a whole and not parsed.

Returning to FIG. 2, the discrete input may be saved in a database and accessed from the database or the discrete inputs may be treated as received. The narrative system uses the discrete inputs to generate a set of linguistic component objects. The linguistic component objects may be categorized as entities and events. Entity objects relate to the things or people, such as patients, complaints, symptoms, and tests. Event objects relate to actions or states related to the entities such as reporting, complaining, alleviating. For example, if a patient reports a complaint, then there are two entities, patient and complaint, and one event, the reporting action. Together, entities and events are used to create sentences in a narrative. An entity object, such as an entity object relating to a patient, may be generated, as shown at step 206. The entity object may, for example, be added to a list of entity objects. The discrete inputs may be used to generate event objects, as shown at step 208. Similarly, the event objects may be added to a list of event objects.

Using the entity and event objects, predicate argument structures (PAS) are generated, as shown at step 210. In one exemplary embodiment, PASs correspond to the clauses in the text. Each event corresponds to a predicate that indicates the action or state involved. Each entity becomes an argument of one of the predicates.

Using the PASs, the narrative system generates a text narrative, as shown at step 212. In one exemplary embodiment, each PAS is converted in a two-step process into a parse tree, from which the final text is produced. The first step performs several functions to produce the overall structure of the clause. The second step occurs with a passive sentence, rearranging the components to create a parse tree that shows the sentence structure of the final text. The parse tree is converted into sentence text, using proper word order (e.g., adjectives preceding nouns). Punctuation and capitalized words are added where appropriate.

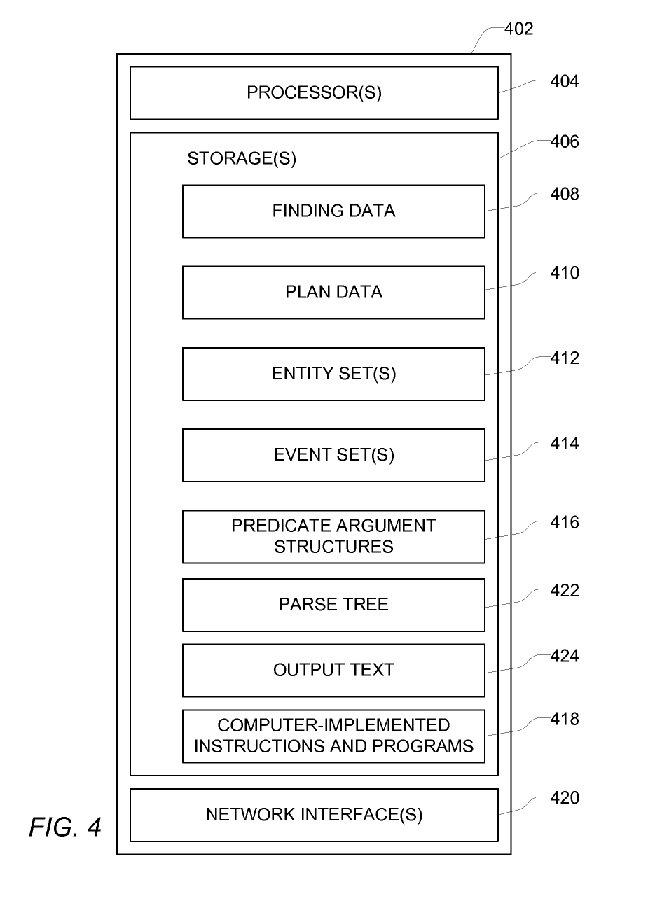

FIG. 4 illustrates an exemplary system for generating text from discrete inputs. The system 402 includes processor(s) 404 and storage(s) 406. The system 402 may also include network interface(s) 420 configured to access remote entry devices. The storage(s) 406 may include medical findings data 408, plan data 410, entity set(s) 412, event set(s) 414, predicate argument structures 416, parse tree 422, output text 424 and computer-implemented instructions and programs 418.

The medical findings data 408 includes one or more discrete inputs, such as individual data items, such as the value entered for the date under Started, “dull” and “burning” under Description, and “moderate” under Severe, as shown in FIG. 3. In one exemplary embodiment, the discrete inputs may indicate the existence of an entity, such as a patient, chief complaint, symptom, test, or order. In another exemplary embodiment, the discrete inputs may modify or describe the entity. In a medical workflow, the discrete inputs may be associated with a stage in a medical workflow. For example, a patient encounter may include the medical workflow steps of a chief complaint (CC), history of present illness (HPI), medication and allergies (Med/All), patient medical family and social history (PMFSH), physical exam (PE), results, diagnosis (DX), Orders, prescriptions (Rx), and notes. The discrete inputs may, for example, include a chief complaint. In addition, the discrete inputs may include data regarding the chief complaint. For example, a chest pain chief complaint may include discrete inputs indicating onset, descriptions, accompanying symptoms, severity, episodes since started, frequency, duration, longest duration, rapidity of onset, location, what precipitates the condition, and what alleviates the condition.

The discrete inputs and the finding data 408 may be stored in a database or be provided directly as received from a remote data entry device. From these discrete inputs, a narrative system generates a text narrative.

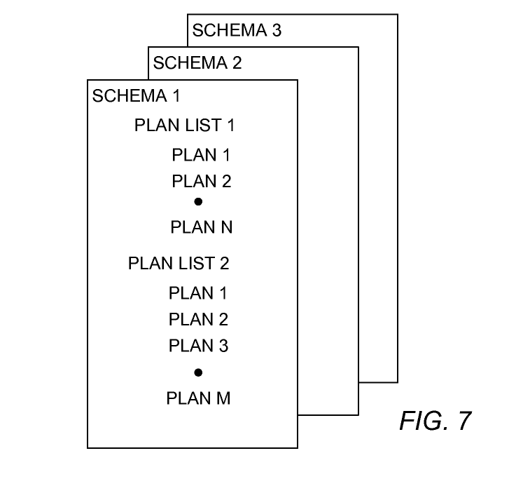

The plan data 410 includes a set of instructions for mapping discrete inputs, such as the medical findings, into a linguistic component, such as an entity or event. In one exemplary embodiment, the plan data includes a set of schema files, each of which include one or more plan list(s) that include one or more plans, as shown in FIG. 7. For example, the schema files may be coded in an XML or text file format. Each schema file may relate to a medical specialty, a stage in a workflow, diseases, complaints, or symptoms. For example, the plan data 410 may include a schema file for diseases, a schema file for symptoms, and a schema file for pediatric complaints. In one particular embodiment, the schema files are read and the plans are converted into plan objects. The plan objects are used to map the discrete inputs. The plans include a set of preconditions that are used to determine whether the plan is applicable and a set of actions that are taken when the plan is applicable. The preconditions may determine whether the discrete input is associated with a particular entity, is associated with a specific category, or is of a specific grammar type, such as a noun or adjective. The actions include creating an entity, creating an event, and modifying an entity or event.

The actions of the plans generally result in a set of entities 412 and a set of events 414. The set of entities 412 may include entity objects, such as objects associated with a patient or complaint. The set of events 414 may include event objects, such as objects associated with reporting, complaining, precipitating, and alleviating. The entity objects and the event objects may be included in lists of entity objects and event objects.

From the event objects and entity objects, predicate argument structures 416 may be generated. The predicate argument structures 416 may include predicate argument structure objects that are used in the process of generating text narratives.

The computer-implemented instructions and programs 418 are operable to direct the processor 404 to generate the text narratives from the discrete inputs. For example, the computer-implemented instructions 418 may be configured to access the findings data 408 and to read the discrete inputs. In a particular embodiment, the computer-implemented instructions 418 are configured to generate linguistic component objects, such as entities 412 and events 414, based on the discrete inputs. The computer-implemented instructions 418 are configured to generate PAS objects 416 from the linguistic component objects 412 and 414 and are configured to generate output text 424 from PAS objects 416. For example, the computer-implemented instructions and programs 418 may generate a parse tree 422 based on the PAS objects 416 and generate the output text 424 based on the parse tree. In one exemplary embodiment, the computer-implemented instructions 418 may generate interfaces for the collection of discrete inputs and the display of generated text narratives.

In one example, a HCP is provided with an interface including elements for entering discrete inputs associated with a complaint. The discrete inputs are stored for access by a narrative generation system. The narrative generation system accesses the data, generates linguistic component objects based on the discrete input data, and generates text narratives based on the linguistic component objects. The narrative generation system may provide the narrative as part of an interface to the HCP or as part of paperwork provided to a third party payer, such as an insurance company or government program.

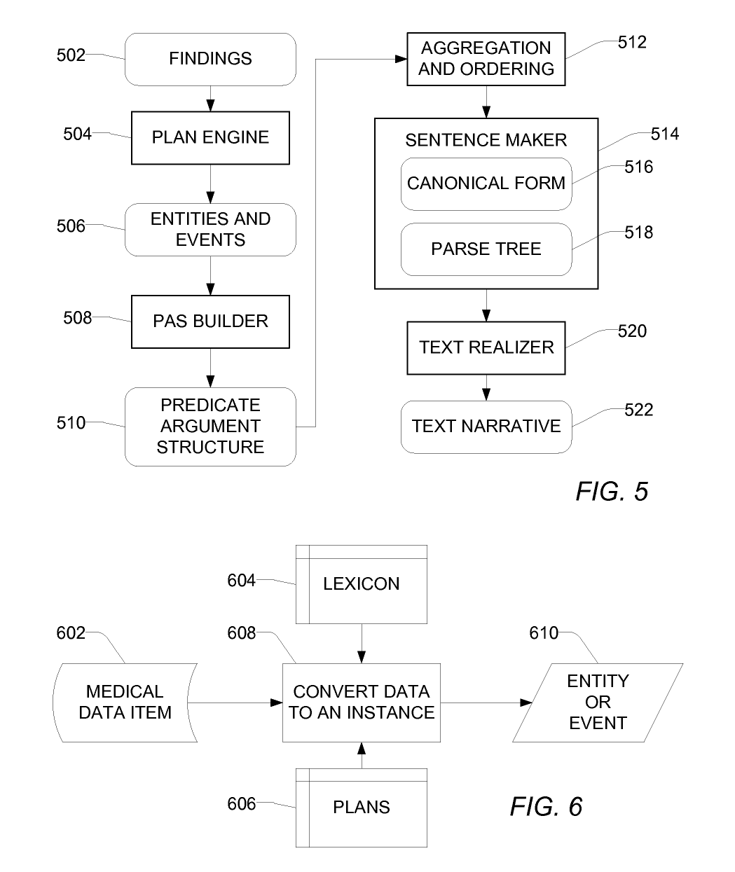

FIG. 5 depicts an exemplary software system for generating a text narrative. Findings data 502 is accessed by a plan engine 504. The plan engine 504 uses plans and a lexicon to generate linguistic component objects, entities and events 506. A PAS builder 508 accesses the linguistic component objects 506 and generates predicate argument structure objects or data 510.

In one exemplary embodiment, the PAS objects 510 are accessed by an aggregation and ordering engine 512 and a sentence maker 514. The PAS objects are used to create canonical form 516 and a parse tree 518. A text realizer 520 generates the text narrative 522. An alternative process for sentence generation from a predicate argument structure may be found in Building Natural Language Generation Systems by Ehud Reiter and Robert Dale, Cambridge University Press, 2000.

FIG. 6 depicts an exemplary process flow for converting discrete inputs to linguistic component objects. Medical data items 602, such as findings, are accessed and processed in accordance with plans 606 and lexicon 604.

The medical data items 602 include discrete inputs. In one exemplary embodiment, the discrete inputs are included in a database. Each input may include an indication of category, its value, and an indication of what it modifies. For example, a complaint discrete input may include an indication that it is a complaint and the complaint's name. A severity discrete input may include an indication that it relates to severity, is an adjective, and is associated with a complaint. Alternately, the discrete input may be an annotation or canned text that is treated as a whole and not parsed.

The discrete input is processed in accordance with a plan 606 and lexicon 604. Plans 606 may include precondition statements and action statements. For example, the format of a plan may be:

<name>

PRECONDITION: <list of preconditions>
ACTION: <action list>

where <name> identifies the plan. In one exemplary embodiment, the plans are named by category, such as Location or Onset, followed by a sequence number. For the plan to apply, the preconditions should match the characteristics of the findings data as well as existing entities/events at the time. The actions list the operations to convert the finding into parts of the appropriate entity or event.

In this exemplary embodiment, plans are organized into plan lists, which in turn are grouped into schemas. Each schema provides the sets of plans for a particular part of patient encounter processing, such as Generic Symptoms HPI. Each plan list includes the plans for a particular finding type, such as Location, Severity, etc. Each plan has a name, a set of preconditions and a set of actions. In one particular example, the schema, plan list and plans may be organized or stored as an XML file. See Table 1 for details.

TABLE 1

| Left Hand Side | Right Hand Side | Arguments/Comments |
|---|---|---|
| <schemalist> | <schema>+ | |
| <schema> | <planlist>+ | Name |
| <planlist> | <preconditions> <plan>+ | name (Location, Severity, etc.) |
| <plan> | <preconditions>precondition* | name: NLP plan class name |
| | </preconditions> | plus sequence number |
| | <actions>action*</actions> | |
| <preconditions> | <NLPPlanClassEquals> \| | current findingvalue item: “.” |
| | <categorynameequals> \| <isTimePhrase> \| | |
| | <isDate> \| <isComplaint> \| <isAdjective> \| | |
| | <isNominal> \| <isPOS> \| <existsEntity> \| | |
| | isNegative \| <contains> \| <matches> \| . . . | |
| <actions> | <createEntity> \| <createEvent> \| | instancename: name of entity |
| | <insertValue> \| <insertPredicate> \| | or event; slotname: name of |
| | <addtoslate> \| <CannedText> | the slot; item: finding |

There are several logical designations for the building blocks of plans: preconditions—which test for true or false; expressions—which return a value; plan_actions—which perform some action; and logical connectives—for combining preconditions. In addition XML statements can have attributes in the form: name=“value”.

Preconditions may include several sets of preconditions: the ones checked at the plan list level and those checked within a plan, either at the beginning of a plan or in a switch/case to further distinguish finding characteristics, such as part of speech. The functionality is the same for these two. Preconditions test findings and circumstances to determine which plan list applies and which specific plan is to be used. Table 2 describes exemplary preconditions.

TABLE 2

| | |
|---|---|
| <categorynameequal test=“xxx” > | tests to see whether a finding belongs |
| | to a particular category |
| <NLPPlanClassEquals test=“xxx”> | tests to see if a finding matches an |
| | NLP plan class |
| <isTimePhrase test=“xxx”> | tests to see if finding is related to time |
| | (e.g., 4 minutes) based on the semtag |
| | in the part of speech table |
| <isDate test=“xxx”> | tests to see if finding is a real date |
| | (e.g., Dec. 25, 2003) |
| <isComplaint > | tests to see if finding is the name of a |
| | complaint |
| <contains word=“xxx” > | tests to see if a finding name contains |
| | a given string |
| <isAdjective> | tests whether the finding name is an |
| | adjective |
| <isNominal> | tests whether the finding name is |
| | nominal, i.e. a noun or noun phrase |
| <isPos pos=“yyy”> | tests for a particular part of speech, |
| | such as “pp” or “adj-comp” |
| <equals> | compares objects |
| <isNegative item=“.”/> | tests for valence = −1 for the current |
| | finding |

Because expressions return a value, they can be used in several ways. The returned value can be tested as part of a precondition, such as <findingValue> in this example: <equals><findingValue item=“.”/>none</equals>. Here the expression <findingValue> is tested to see whether its returned value is equal to the finding value “none”. The value returned by an expression can also become part of the output. Table 3 lists some of the expressions. The “findingValue” tag returns the value of the current finding. It is used in preconditions and action statements to indicate that the value of the current finding is to be inserted there. The “categoryname” tag is used inside preconditions and action statements when the name of the category is to be inserted. It returns the name of the category for the current finding.

TABLE 3

| | |
|---|---|
| <findingValue> | returns the finding value of the item |
| | indicated |
| <categoryname> | returns name of the category to which the |
| | finding belongs (up one level in the |
| | ancestry, usually) |
| <replaceComponent> | use a identifying expression to replace a |
| | component with a different component |
| <slotvalue> | returns the value already set up in a slot; |
| | useful for comparison or duplicating a |
| | value |
| <getword> | returns the word at the specified index in |
| | the input where index is a number |

Actions build the entities and events used for constructing clauses and sentences. Actions include Create an instance, Insert a value into a slot in an instance, Add to the slate, and a special case action called CannedText. Within actions, the order of attributes is flexible but for consistency should follow the order: instancename, slotname, other arguments. See Table 4 for details about actions.

TABLE 4

| | |
|---|---|
| <createEntity instancename=“xxx”/> | creates an Entity and gives it a |
| | name |
| <createEvent instancename=“xxx”/> | creates an Event and gives it a |
| | name |
| <insertValue instancename=“xxx” | defines a slot and indicates the |
| slotname=“yyy” ...> | value to be inserted |
| <insertPredicate instancename=“xxx” ...> | Indicates the predicate value for |
| | an Event |
| <addToSlate instancename=“xxx” | puts information on the slate |
| slotname=“yyy” ...> | associated with an instance for |
| | later processing |
| <CannedText> | creates a text string that will |
| | become the actual sentence in |
| | the narrative |

The “createEntity” and “createEvent” tags create an instance and give it a name. The “insertValue” tag is used to add the slots for the arguments in that instance and to give them values. The “insertPredicate” tag is a special case of the “insertValue” tag with slotname=“predicate”.

The slate is used to hold information that does not fit into an instance slot, but may be used before the sentence can be generated, such as tense or prepositions to be used as sentence adjuncts. The syntax for addToSlate is similar to insertValue, with the name of the slot indicating how the information may be identified on the slate. For example, this addToSlate statement would save the tense information for this plan. <addToSlate instancename=“Numbness” slotname=“tense”>past</addToSlate>

If a prepositional phrase is to be described (where the current findingValue is the object), this statement would work:
<addToSlate instanceName=“Quality” slotName=“pp”>in <findingValue item=“.”/></addToSlate>

Information that can be added with <addToSlate> includes: tense: past, present perfect [default=present]; voice: passive [default=active]; and pp: <prep>+<findingValue>.

The “CannedText” action is used sparingly for those situations where building a sentence would be too complicated. Sometimes the verb is rare and may not be set up as a predicate. Other times the form of the sentence would be complicated. An example of CannedText includes:
<CannedText>the amount of weight gained with @complaint is <findingValue item=“.”/></CannedText>

In writing preconditions, the ability to combine several may be used to establish a test. Within the <preconditions> opening and closing tags, a number of individual preconditions can be written using an implied AND combination as well as the explicit AND expression. An exclusive or (XOR) may be used for selecting one of several conditions, as well as logical <OR>. For example, here the finding is tested to determine whether the finding is either an adjective or adjective complement.

<preconditions>
<OR>

<isAdjective item=“.”/>
<isPOS pos=“adj-comp” item=“.”/>

```
  </OR>
  <categorynameequals test = “Timing” item=“.” />
</preconditions>
```

In the case of attributes, the XOR test can be done by including more than one choice within quotes, separated by vertical bars:

<preconditions>

<contains word=“Amount of|Estimated amount of|Estimated volume

of”><categoryname item = “.”/></contains>
</preconditions>

Each tag or expression may invoke a function call or access a class. In one exemplary embodiment, each tag or expression has an associated Java class.

Referring to FIG. 6, the lexicon 604 for example includes word references and indications of grammar type, such as noun, verb, adjective, and adverb. It may also be used to indicate semantic information about a word or phrase, such as that “spine” refers to a location.

A plan engine converts the medical data item to an instance, as shown at process 608. The instance results in creation of or change to an entity or event 610. An entity may take the form:

[ENTITY <entity_id>

[HEAD <entity_name>]
[MOD <adj>*]
[POST_MOD <pp>]*]

where <entity_id> is the name of a finding. Modifiers are generally adjectives. Post_modifiers may turn into prepositional phrases during lexicalization.

An event may take the form:

[EVENT <event_id>

[HEAD <predicate>]
[<role_name> <entity_id>]*]

where <role_name> can be THEME, AGENT, INSTRUMENT, etc. The tag <event_id> is made up from the name of the plan list, the predicate and the category of the finding.

Once the entities and events are created and the discrete inputs processed, the entities and events may be used to generate a text narrative. In one exemplary embodiment, the entities and events are used to generate predicate argument structures. These predicate argument structures are used to generate parse trees and canonical forms, which are used to generate the text narrative.

The general format for a PAS is:

<predicate_name>

[<role_name> <role_value>]*]

<role_name> is determined by the <predicate_name> which determines the <role_value>. For example, if the Predicate chosen is “describe”, then the roles associated with that predicate may be Agent and Theme. This method follows Charles Fillmore's notions of Case Grammar. The sentence pattern is generally determined by the verb or verbs associated with a particular predicate, as indicated in the predicate argument structure.

In one exemplary embodiment, the narrative system receives a set of discrete inputs. For example, a patient may complain of abdominal pain. A finding may include “periumbilical” whose category is “initial location.” Using one or more plans, two entity objects and an event object may be generated.

The plan may, for example, be associated with location, such as the following example:

<plan name=“Location4”>
<preconditions>

<categorynameequals test=“Initial Location” item=“.”/>

```
  </preconditions>
  <actions>
    <switch>
```

<case><isNominal item=“.”/>
<block>

<createEvent instancename=“.category” predicate=“begin”/>
<insertValue instancename=“.category”

slotname=“theme”>@complaint</insertValue>

<insertValue instancename=“.category” slotname=“comp”>in

the <findingValue item=“.”/></insertValue>

<addToSlate instancename=“.category”

slotname=“tense”>past</addToSlate>

```
  </block>
</case>
<case><isAdjective item=“.”/>
  <block>
```

<createEvent instancename=“.category” predicate=“be”/>
<insertValue instancename=“.category”

slotname=“theme”><categoryname item=“.”/></insertValue>

<insertValue instancename=“.category” slotname=“comp”

item=“.”/>

<addToSlate instancename=“.category”

slotname=“tense”>past</addToSlate>

</block>

```
    </case>
    <case><isPOS pos=“adv” item=“.”/>
```

<block>

<createEvent instancename=“.category” predicate=“begin”/>
<insertValue instancename=“.category”

slotname=“theme”><categoryname item=“.”/></insertValue>

<addToSlate instancename=“.category”

slotname=“comp”><findingValue item=“.”/></addToSlate>

<addToSlate instancename=“.category”

slotname=“tense”>past</addToSlate>

</block>

```
    </case>
    </switch>
  </actions>
</plan>
```

For example, a patient entity object may be generated as follows:
Name: patient
Type: entity
Slots:

lastname Value: Mr Bell

head Value: Mr Bob Bell

fullname Value: Bob Bell

A complaint objected may be generated as shown below:
Name: Complaint
Type: entity
Slots:

head Value: abdominal pain

In addition, an event object such as an initial location object may be generated as shown below:
Name: Location initial location be
Type: event
category Value: initial location
predicate Value: be
nlpPlanClass Value: Location
Slots:

theme Value: initial location

theme[type] Value: np
comp Value:

Name: periumbilical

Value: periumbilical

valence: 1
SLATE: Name: null
Type: slate
Slots:

tense Value: past

In the exemplary event object, the “valence” value of 1 indicates that an interface box was checked. Based on these linguistic component objects, a text narrative may be generated. For example, the system produces “Initial location was periumbilical.”

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A system comprising:
a processor; and
storage accessible by the processor, the storage including:
medical findings data including a discrete input;
computer-implemented program instructions configured to access the medical findings data and configured to generate at least a portion of a medical narrative based on the discrete input.

2. The system of claim 1, wherein the computer-implemented program instructions are configured to generate an event entry based on the discrete input in accordance with plan data.

3. The system of claim 2, wherein the plan data includes precondition data.

4. The system of claim 2, wherein the plan data includes action data.

5. The system of claim 2, wherein the computer-implemented program instructions are configured to generate a predicate argument structure based on the event entry.

6. The system of claim 5, wherein the computer-implemented program instructions are configured to generate the at least a portion of the medical narrative based on the event entry.

7. The system of claim 1, further comprising a network interface accessible to the processor.

8. The system of claim 7, further comprising computer-implemented program instructions configured to receive medical findings data via the network interface.

9. The system of claim 8, wherein the medical findings data is received from a remote device.

10. The system of claim 7, further comprising computer-implemented program instructions configured to provide the medical narrative to a remote device via the network interface.

11. A system comprising:
a processor; and
storage accessible to the processor, the storage including:
data including a discrete input;
a plan file; and
computer-implemented instructions configured to access the data and configured to form a linguistic component object.

12. The system of claim 11, further comprising computer-implemented instructions configured to access the linguistic component object and configured to form a canonical form narrative based on the linguistic component object.

13. The system of claim 12, wherein the computer-implemented instructions configured to generate the canonical form narrative are configured to generate a predicate argument structure based on the linguistic component object and are configured to generate the canonical form narrative based on the predicate argument structure.

14. The system of claim 12, wherein the canonical form narrative is associated with a stage in a medical workflow.

15. The system of claim 11, wherein the plan file includes a precondition statement.

16. The system of claim 11, wherein the plan file includes an action statement.

17. The system of claim 11, wherein the data includes medical findings data.

18. The system of claim 11, further comprising computer-implemented instructions configured to access the plan file and generate plan objects.

19. A computer-implemented method for generating a medical narrative, the method comprising:
accessing a discrete input associated with a medical finding; and
generating a medical narrative based on the discrete input.

20. The method of claim 19, further comprising generating event data in accordance with a plan class and based on the discrete input.

21-26. (canceled)
